(19) United States
(12) Patent Application Publication
(10) Pub. No.: US 2008/0183725 A1
(43) Pub. Date: Jul. 31, 2008

(54) METADATA SERVICE EMPLOYING COMMON DATA MODEL

(75) Inventors: Jose A. Blakeley, Redmond, WA (US); Atul Adya, Redmond, WA (US); Subramanian Muralidhar, Bellevue, WA (US); Sergey Melnik, Kirkland, WA (US); Shyamalan Pather, Seattle, WA (US); Xiaosong Yang, Sammamish, WA (US); Srikanth Mandadi, Redmond, WA (US); Pratik Patel, Redmond, WA (US); Brahmnes Tsz Foon Fung, Sammamish, WA (US); Kawarjit Bedi, Sammamish, WA (US); Daniel G. Dosen, Seattle, WA (US); Timothy I. Mallalieu, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/669,376

(22) Filed: Jan. 31, 2007

(51) Int. Cl. G06F 17/30

(52) U.S. Cl. 707/100; 707/E17.005

(57) ABSTRACT

A data processing and storage system is provided. The system includes an aggregator component that stores metadata from at least two disparate data domains. A framework component encapsulates the metadata according to an abstraction model that describes the disparate data domains.

### BACKGROUND

Computational and memory demands on computing systems continue to increase exponentially as technology develops newer and ever more powerful applications. One such area that has seen recent growth relates to requirements that database processing technologies. These technologies deal with dimensional aspects such as row and column processing and are now being coupled with other processing models such as traditional object models having a class/inheritance structure. Thus, many systems often have a need to support both relational database models and object based models where there also needs to be methods in place to bridge the gap between these models. In contrast to concrete programming models described above, other types of models include conceptual models that are viewed as design artifacts that allow developers to describe components in terms of desired structure. Demands to support such models are often placed on available operating systems where a plurality of applications interact with the operating system but employ the system to interact with other applications. Some discussion on these differing types of models is now provided before a discussion on metadata aspects of applications employing such models.

Object-oriented programming (OOP) is a programming language relates to classes or types which encapsulate state and behavior. Historically, a program has been viewed as a logical procedure that takes input data, processes it, and produces output data. The programming challenge was seen as how to write the logic, not how to define the data. Object-oriented programming takes the view that what one really is interested in are the objects to manipulate rather than the logic required to manipulate them. Examples of objects range from human beings (described by name, address, and so forth) to buildings and floors (whose properties can be described and managed) down to the display objects on a computer desktop (such as buttons and scroll bars).

One aspect in OOP is to identify the objects to manipulate and how they relate to each other, an exercise often known as object modeling. When an object has been identified, it can be generalized as a class of objects. Then, define the type of data it contains and any logic sequences that can manipulate it. Each distinct logic sequence is known as a method. A real instance of a class is called an “object” or, in some environments, an “instance of a class.” The object or class instance is what executes on the computer. The object's methods provide computer instructions and the class object characteristics provide relevant data. In contrast to object models, relational database models are now described.

The relational model provides a model for describing structured data based on an assertion that all data can be described as a series of n-ary relationships. At the core of the relational model is the ability to describe any structure in terms of a series of related tuples which one can reason about with relational algebra. The relational model supports common relational databases that are often supported by some type of query language for accessing and managing large amounts of data. Structured Query Language (SQL) is a prevalent database processing language and may be the most popular computer language used to create, modify, retrieve and manipulate data from relational database management systems. In general, SQL was designed for a specific, limited purpose—querying data contained in a relational database. As such, it is a set-based, declarative computer language rather than an imperative language such as C or BASIC which, being general-purpose, were designed to solve a broader set of problems.

Conceptual models typically provide a grammar with which one can describe a model. Conceptual models are typically, just as described, conceptual—where they have typically been design time artifacts that are realized in terms of database schemas or object models. Conceptual models provide developers with a tool to describe the behavior or nature of a problem in an abstracted manner, where schemas are often employed as a component of such models. For example, a conceptual schema, or high-level data model or conceptual data model, provides a map of concepts and their relationships. A conceptual schema for an art studio, for example, could include abstractions such as student, painting, critiques, and showcases.

Regardless, of the model employed in a respective system such as an object model, relational database model, conceptual model or other model, there is common requirement that is associated with each of the respective models which includes having metadata associated with each of the models. Metadata includes information that characterizes data and describes the structure of the data. For instance, metadata is often used to provide documentation for software components, for presentation of data, or provide information as to how certain data came into being or the details regarding the particular aspects of the respective model that the data relates to. Typically, an application or framework developer that requires access to metadata across several different metadata domains must implement special case logic to deal with these disparate representations of metadata. Furthermore, any correlation between the disparate systems or attempts to be agnostic in terms of the sources of the metadata requires explicit special case logic and abstractions to be implemented. Such an approach to processing metadata is not sufficient for modern development platforms.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

An architecture and programming interface is provided that allows processing of metadata according to a common development/interface framework. Metadata is aggregated from disparate data domains such as from an object domain, conceptual domain, relational domain, or other data domain. As the metadata is collected or aggregated from multiple data sources, it is stored in a manner that is abstracted from the form from which the metadata was collected. Application Programming Interfaces (APIs) are provided that allows access to and manipulation of the abstracted metadata such as via queries or other types of data access, where the APIs provide methods for common access patterns. By providing a common form to collect/manipulate metadata, complex interfaces dealing with the nuances of each respective domain can be mitigated while component development across differing data models simplified.

In one aspect, aggregation services for disparate metadata sources are provided. This includes providing abstractions for processing metadata from different sources including an item collection which understands how to self-populate metadata from a persistent source. In one specific example, this can include a metadata workspace for aggregation that registers multiple item collections and how to dispatch query requests to the appropriate item collections. The metadata workspace and item collection provide an example system, where the broader concept provides an abstraction for sourcing and realizing disparate metadata in terms of a common grammar and API. An aggregator allows one to utilize metadata across different domains with a common API or facade over the lower abstraction (e.g., the workspace). The item collection abstraction exposes a query-able collection of metadata concepts and encapsulates loading, serialization, and validation logic, for example, which simplifies development by providing a consistent framework. The Metadata Workspace provides a registration service for registering a number of item collections and a common framework over the item collection's query API's.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating a metadata processing and storage system.

FIG. 2 is a flow diagram that illustrates an example metadata aggregation process.

FIG. 3 is an example metadata processing and aggregation system.

FIG. 4 illustrates example services for a metadata aggregation and processing system.

FIG. 5 illustrates metadata that applies to provider-specific and consumer-specific metadata extensibility examples.

FIG. 6 illustrates example metadata processing aspects.

FIG. 7 is a schematic block diagram illustrating a suitable operating environment.

FIG. 8 is a schematic block diagram of a sample-computing environment.

### DETAILED DESCRIPTION

A common framework providing abstraction interfaces and storage over disparate metadata sources is provided. In one aspect, a metadata processing and storage system is provided. The system includes an aggregator component that stores metadata from at least two disparate data domains. A framework component encapsulates the metadata according to an abstraction model that describes the disparate data domains. One or more application programming interfaces can be provided to interact with the aggregator component to facilitate data access according to the abstraction model.

As used in this application, the terms “component,” “API,” “aggregator,” “model,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

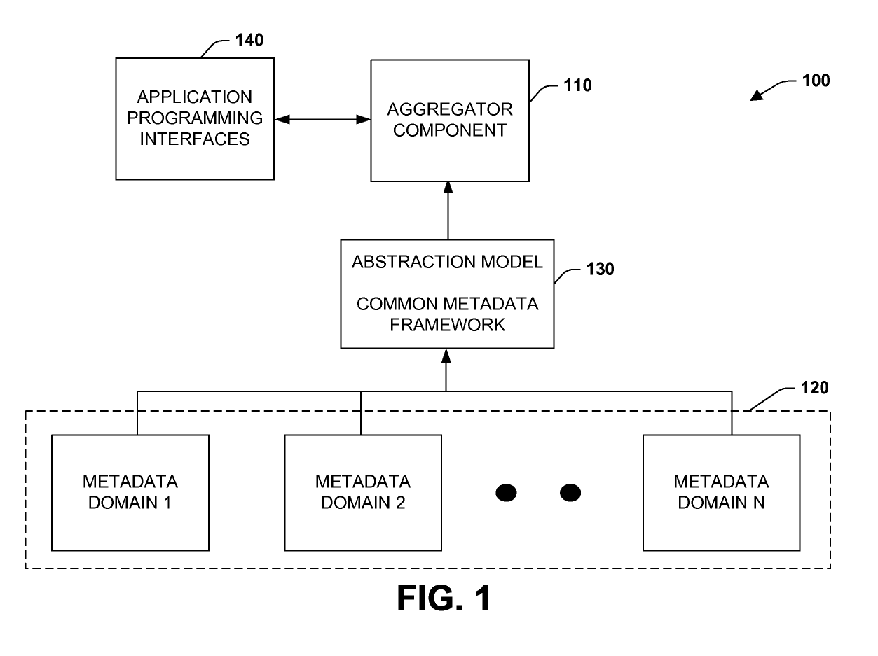

Referring initially to FIG. 1, a metadata processing and storage system 100 is illustrated. The system 100 includes an aggregator component 110 that receives and stores data from one or more disparate metadata domains 120. Data received from the metadata domains 120 is collected as part of an abstraction meta-model or framework 130 that encapsulates the metadata from its original source 120 and stores the data in a transparent/generic form at the aggregator component 110. Data can be manipulated and processed at the aggregator component 110 via one or more application programming interfaces APIs 140 in order to access the encapsulated metadata provided by the abstraction meta-model 130. As will be described in more detail below, the APIs 140 can allow such aspects as queries to be performed to manipulate metadata in the aggregator component 110. Also, the metadata domains can be associated with substantially any type of data model where a singular metadata grammar is employed to represent multiple metadata domains. Such metadata domains 120 can be associated with Object Models, Relational Models, Service Contracts, Process Contracts, Conceptual Models, Reporting Models, and Analytical Models, for example.

The aggregator component 110 and programming interfaces 140 allow processing of metadata 120 according to a common development/interface framework. Metadata is aggregated at 110 from disparate data domains 120 such as from an object domain, conceptual domain, relational domain, and/or other data domain. It is noted that the aggregator component 110 can also store mapping information and can be considered another form of metadata, but may or may not be considered a separate domain. As the metadata is collected or aggregated from multiple data sources at 110, it is stored in a manner that is abstracted via the meta-model 130 from the form from which the metadata 120 was collected. Application Programming Interfaces (APIs) 140 are provided that allows access to and manipulation of the abstracted data such as via queries or other types of data access. By providing a common/abstracted form to collect/manipulate metadata at 110, complex interfaces dealing with the nuances of each respective metadata domain 120 can be mitigated while component development across differing data models can be simplified.

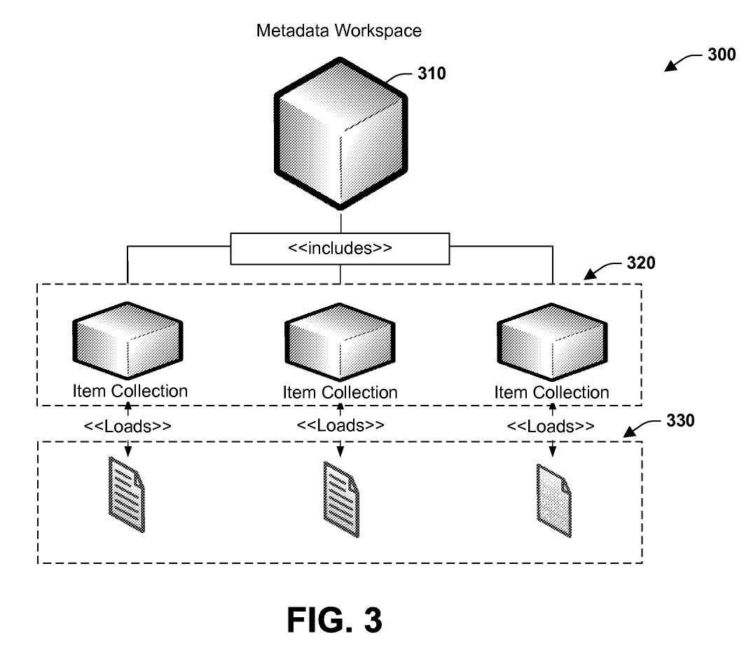

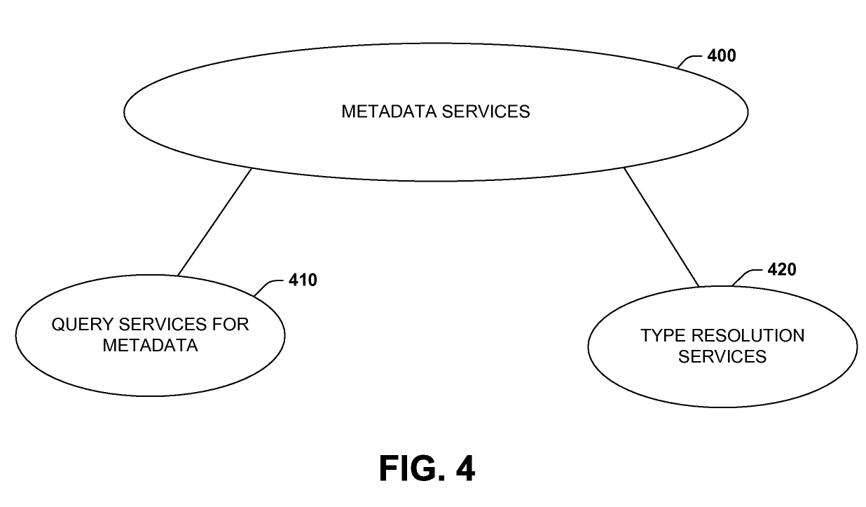

In one aspect, aggregation services (described in more detail with respect to FIG. 4) for disparate metadata sources 120 are provided. This includes providing abstractions for processing metadata from different sources including an item collection which understands how to self-populate metadata from a persistent source. This can include a metadata workspace (described in more detail with respect to FIG. 3) for aggregation that registers multiple item collections and how to dispatch query requests to the appropriate item collections. In addition to dispatching query requests, the workspace can also fulfill requests that a single item collection could not handle by itself. For example, the workspace can provide a service method that determines, for a given type, the equivalent type in another domain by consulting the item collections for the two domains as well as the item collection that stores the mapping between the two domains. The item collection abstraction exposes a query-able collection of metadata concepts and encapsulates loading, serialization, and validation logic, for example, which simplifies development by providing a consistent framework. The metadata workspace provides a registration service for registering a number of item collections and a common framework over the item collection's query API's as well as higer-level services as described above.

It is noted that in the context of the system 100, the term query refers to generalized questions that may be asked of aggregator component 110 or the metadata workspace. For instance, one may invoke a finder-like operation (such as get Item (String Identity)) where attempts are made to find an item by its identity. Similarly, one may leverage Language Integrated Query or other type (example object query language (OQL)) constructs to execute a more expressive query over the in-memory metadata instances.

In general, databases can be used to store structured data in one example. The structure of this data, together with other constraints, can be designed using a variety of techniques, one of which is referred to as entity-relationship modeling or ERM. The end-product of the ERM process is an entity-relationship diagram or ERD. Data modeling often employs a graphical notation for representing such data models. An ERD is a type of conceptual data model or semantic data model.

The first stage of information system design uses these models to describe information needs or the type of information that is to be stored in a database during the requirements analysis. The data modeling technique can be used to describe any taxonomy (i.e., an overview and classifications of used terms and their relationships) for a certain universe of discourse (i.e., area of interest). In the case of the design of an information system that is based on a database, the conceptual data model is, at a later stage (usually called logical design), mapped to a logical data model, such as the relational model, this in turn is mapped to a physical model during physical design. It is noted that sometimes these phases are referred to as “physical design.” Thus, the metadata domains 120 can be associated with different models and/or different stages of the modeling process, where each stage or portion of the model can have a different metadata domain. Before proceeding, it is noted that the system 100 can be provided as a metadata aggregation system. This includes means for aggregating metadata (aggregator component 110) from one or more metadata domains 120. This can also include means for representing the metadata (abstraction model 130) according to a common data meta-model, where the represented data applies as a generic form across the metadata domains 120.

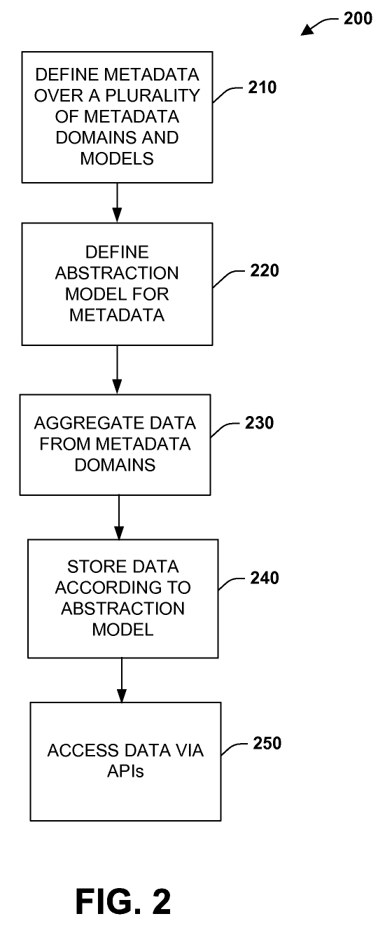

Referring now to FIG. 2, an exemplary metadata aggregation process 200 is illustrated. While, for purposes of simplicity of explanation, the process is shown and described as a series or number of acts, it is to be understood and appreciated that the subject processes are not limited by the order of acts, as some acts may, in accordance with the subject processes, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject processes described herein.

At 210, metadata is defined over a plurality of metadata domains and according to various models. For example, such models could include object models, relational database models, and conceptual models. Thus, metadata can be associated with each type of respective data model which can vary across data domains. At 220, an abstraction is defined for the various metadata forms defined at 210. Such abstraction includes an encapsulated form where the particulars of the metadata and its associated data model are abstracted or generalized in view of the form. This can include defining abstract interfaces and methods that are called in a generic manner regardless of the underlying form of the metadata or the associated model from which the metadata is derived. At 230, metadata is aggregated from across the metadata domains described above. This can include pulling data in across a network (or networks) from multiple data sources and storing the metadata according to the generic or framework forms dictated by the respective abstraction model such as shown at 240. Thus, when the metadata data is accessed in the future, it will be manipulated via its generic or encapsulated form as opposed to its original form and model structure. At 250, after the data is stored in its abstracted form, the data can be manipulated via one or more application programming interfaces.

As will be described in more detail below, the abstraction and interface principles described by the process 200 enable various features and functions. This includes:

Providing a Metadata Workspace as an aggregator and framework over disparate metadata;

Providing a Metadata Item Collection as an extensible model for loading and managing metadata from a persistent source;

Providing a Metadata Type Hierarchy as an in-memory realization of an Entity Data Model (or other data models that employ metadata);

Providing a Metadata Perspective as a component for abstracting the type and source of metadata from consumers;

Enabling Projection of a conceptual model on to a target system;

Employing a Provider Manifest as a component for defining a concrete set of types and type semantics; and

Enabling Query services for metadata described in terms of the respective model. As can be appreciated, other features and functions can be provided by the abstractions and APIs described herein.

Referring now to FIG. 3, an example metadata processing system 300 is illustrated. As shown, the system 300 can include a metadata workspace 310 that is fed from one or more item collections 320, which are in turn fed by respective metadata documents 330 such as schemas and other types of model data and/or associated metadata. As will be described in more detail below with respect to FIGS. 3 and 4, metadata services and extensibility options can also be provided with the system 300.

In order to have a common way to query over the metadata 310 and to reason about or relate metadata from disparate sources at 320, a common model such as an abstraction model described above is provided to express the metadata. For instance, metadata surfaced in the Metadata Workspace 310 can be describable in terms of a common meta-model. The common meta-model in one example can be an Entity Data Model (EDM) described above. An instance of the EDM can be used to describe and relate the following types of metadata in an Entity Data Platform:

Conceptual Models: Models that describe domain entities at a conceptual level that may be realized in classes and/or database tables;

Database Models: Models that describe a database (tables, relationships, constraints . . . );

Client Mappings: Models that describe the relationship between a conceptual model instance and a database model instance;

Object Mappings: Models that describe the relationship between a class and a conceptual Entity;

Primitive Type Mappings: Mappings between primitive types and a target database's primitive types. This can include mapping between EDM primitives and CLR (common language runtime) primitive as well as EDM primitives and target database primitives. By providing intermediary primitive types and the EDM meta-model, a neutral “canonical” representation of both shape and primitive enables a system to perform any model-model transformation; and

Type Semantics: Services that describe common semantics for types (comparable, promote-able . . . ). As can be appreciated, more or less metadata components can be provided than the examples described herein. After metadata components have been suitably abstracted, services for accessing/manipulating such metadata can be provided such as described in more detail below with respect to FIG. 4.

Referring now to FIG. 4, example services 400 for a metadata aggregation and processing system is illustrated. At 410, Query Services for Metadata can be provided. One of the aspects for metadata services is that metadata from disparate sources can be treated as model instances where the common meta-model is the EDM described above or other model. This allows platforms to execute queries (beyond identity based lookups) in terms of entity types and the relationships they hold to other entity types. A system could, for example, execute a query such as:

Return all Mappings where the Conceptual Entity Type is in the “com. company” namespace and the Target (database) Entity Type has a property (column) named “Salary.” This is a more expressive and powerful component for interacting with metadata than the typical approaches of iterating through arrays of methods. It also underscores the capability of leveraging metadata from disparate sources. In such a query at 410, the conceptual model, the database model and the client mapping participate to yield the desired results.

At 420 of FIG. 4, type resolution services across disparate type systems can be provided. When the shape of entities are described, leaf members are often described in terms of primitive types, where primitive types are type intrinsic to the type system, and cannot be further decomposed into simpler types. The Entity Data Model can be a meta-model for describing the shape of concepts in a type system agnostic manner. For instance, when describing UML artifacts, database schemas, java classes or other classes. The EDM, to facilitate the notion of a primitive type, provides a set of abstract primitive types that serve as markers so that a model can be translated across type systems (e.g., java-CLR or DB2-SQL Server) without having to alter the abstract representations.

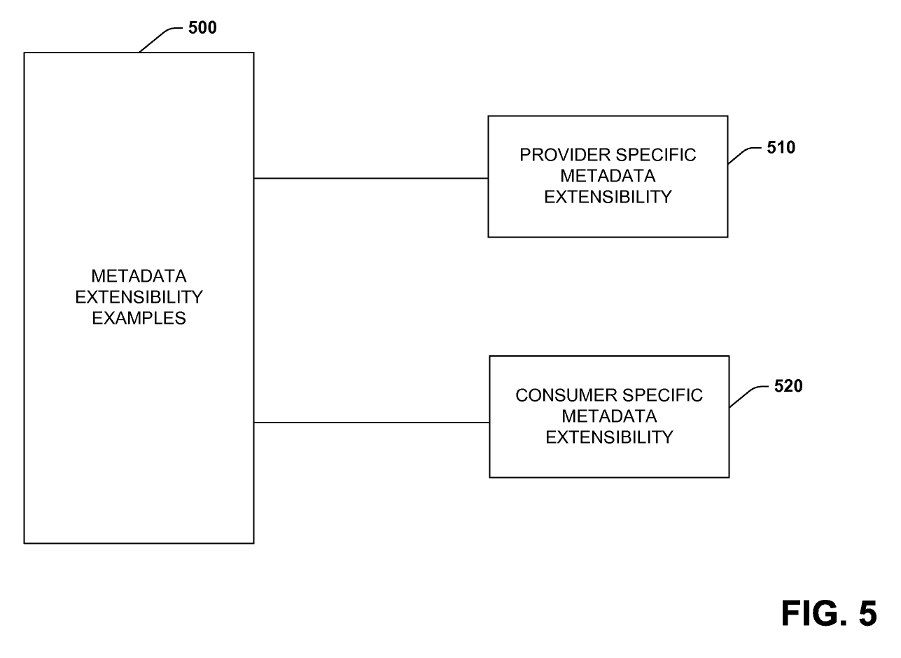

The metadata runtime services use abstract primitives and a metadata hierarchy as a canonical schema which can serve as the intermediate transformation point between two real type systems. Such an intermediary schema supports an n-1 model transformation, where n type systems plus the canonical representation of primitives map to a canonical representation instead of to the n-1 other type systems. This helps provider writers by reducing the set of types they need to be concerned with other than just EDM types, as opposed to every other type system that might exist. The Metadata runtime services also provide the components for loading the concrete transformations to be used in a given context plus the type semantics to be used in the given context. Consumers of the metadata runtime services can perform transformations of primitive types or reason about the semantics of a given primitive type from a particular type system. Along with respective metadata services, now metadata extensibility examples will be described in more detail below with respect to FIG. 5.

Referring to FIG. 5, metadata extensibility examples 500 are illustrated. At 510, provider specific metadata extensibility can be provided. In general, provider writers can extend metadata by specializing the Item Collections or by adding new Item Collections that capture new metadata. Provider writers may also provide the specific types, functions and respective mappings to the EDM abstract primitive types through a Provider Manifest abstraction, where each provider writer can be implemented as a standard set of interfaces, and may have included both required and optional interfaces. The Provider Manifest is a declarative model for describing a provider's primitive types, type semantics and functions in XML. The Metadata runtime model loads this manifest to satisfy the type resolution and type semantics services described above.

At 520, consumer specific metadata extensibility can be provided. Consumers of the metadata runtime model may also register their own item collections or specialized item collections in order to load metadata from different sources. A more common scenario is that a consumer may want to decorate an existing metadata instance with more information that is contextually useful to the application or framework being constructed. The metadata runtime supports design and runtime decoration of members and types by consumers through the use of attributes and facets.

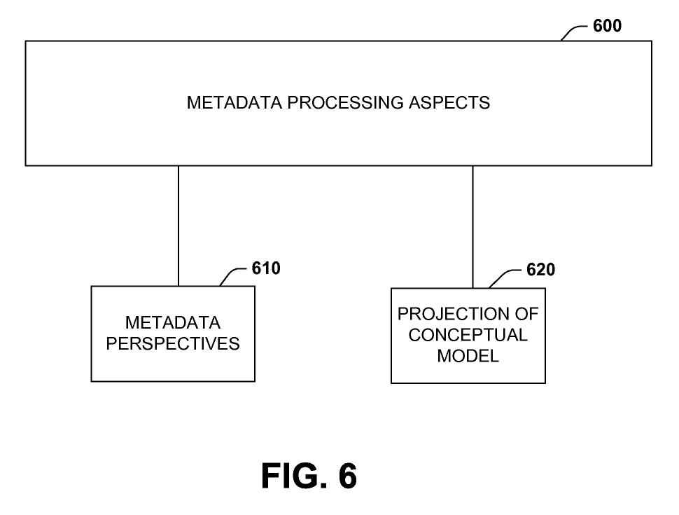

Turning to FIG. 6, example metadata processing aspects 600 are illustrated. Proceeding to 610, Metadata Perspectives are considered. Consumers of the metadata workspace, such as query parsers, often want to reason about a type from one domain in terms of the primitive types from another domain. One example is an Entity Type mapped to a database table: a query parser processing a query over the entity type may desire to observe the type defined in terms of the database's primitive types, rather than the EDM's abstract primitive types. This facilitates easier reasoning about type semantics. In order to support such a scenario the metadata perspective has been introduced, the metadata workspace provides an API that abstracts details of type transformation and mapping and allows a consumer to ask questions of the workspace and consistently receive the results in terms of the target domain's primitive type system.

At 620, projection of a conceptual model onto a target type system is considered. At runtime, there are at least two type systems in a typical solution—the type system of the object runtime and the Target store's type system (the type system of the underlying database). In the EDM and Entity Services, conceptual models are generally defined in terms of abstract primitive types that can be mapped to one of these concrete type systems. The realization of a model at runtime causes it to be bound to the target type system before operation execution can take place. The binding facilitates store agnostic definition of models which become concrete and usable in the context of an underlying store.

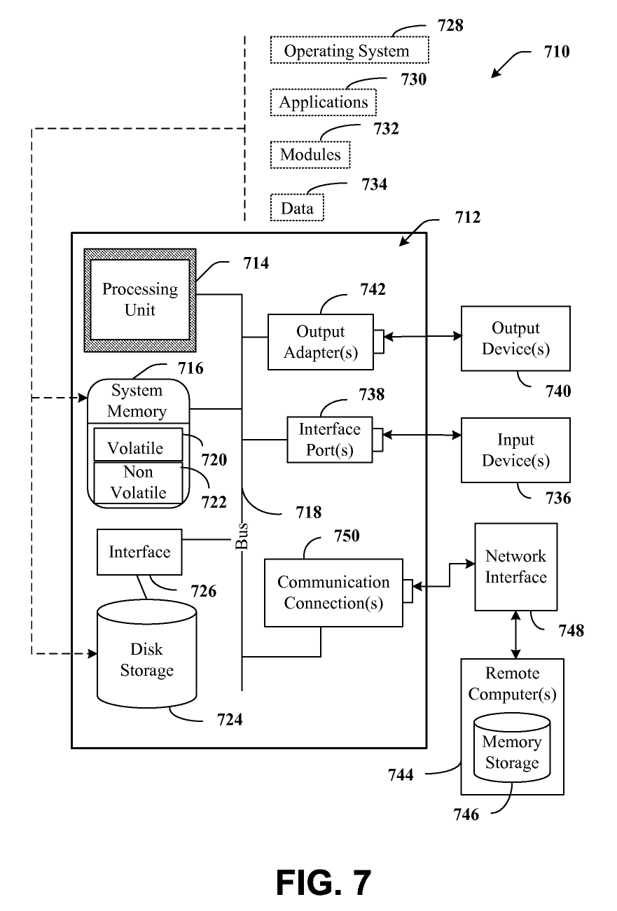

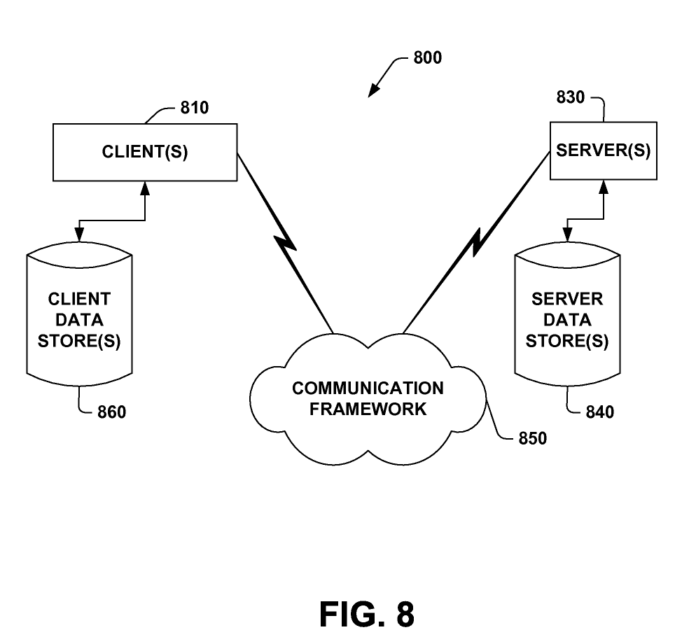

In order to provide a context for the various aspects of the disclosed subject matter, FIGS. 7 and 8 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that performs particular tasks and/or implements particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 7, an exemplary environment 710 for implementing various aspects described herein includes a computer 712. The computer 712 includes a processing unit 714, a system memory 716, and a system bus 718. The system bus 718 couple system components including, but not limited to, the system memory 716 to the processing unit 714. The processing unit 714 can be any of various available processors. Dual microprocessors and other multiprocessor architectures also can be employed as the processing unit 714.

The system bus 718 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 716 includes volatile memory 720 and nonvolatile memory 722. The basic input/output system (BIOS), containing the basic routines to transfer information between elements within the computer 712, such as during start-up, is stored in nonvolatile memory 722. By way of illustration, and not limitation, nonvolatile memory 722 can include read only memory (ROM), programmable ROM (PROM), electrically programmable ROM (EPROM), electrically erasable ROM (EEPROM), or flash memory. Volatile memory 720 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 712 also includes removable/non-removable, volatile/non-volatile computer storage media. FIG. 7 illustrates, for example a disk storage 724. Disk storage 724 includes, but is not limited to, devices like a magnetic disk drive, floppy disk drive, tape drive, Jaz drive, Zip drive, LS-100 drive, flash memory card, or memory stick. In addition, disk storage 724 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 724 to the system bus 718, a removable or non-removable interface is typically used such as interface 726.

It is to be appreciated that FIG. 7 describes software that acts as an intermediary between users and the basic computer resources described in suitable operating environment 710. Such software includes an operating system 728. Operating system 728, which can be stored on disk storage 724, acts to control and allocate resources of the computer system 712. System applications 730 take advantage of the management of resources by operating system 728 through program modules 732 and program data 734 stored either in system memory 716 or on disk storage 724. It is to be appreciated that various components described herein can be implemented with various operating systems or combinations of operating systems.

A user enters commands or information into the computer 712 through input device(s) 736. Input devices 736 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 714 through the system bus 718 via interface port(s) 738. Interface port(s) 738 include, for example, a serial port, a parallel port, a game port, and a universal serial bus (USB). Output device(s) 740 use some of the same type of ports as input device(s) 736. Thus, for example, a USB port may be used to provide input to computer 712 and to output information from computer 712 to an output device 740. Output adapter 742 is provided to illustrate that there are some output devices 740 like monitors, speakers, and printers, among other output devices 740 that require special adapters. The output adapters 742 include, by way of illustration and not limitation, video and sound cards that provide a means of connection between the output device 740 and the system bus 718. It should be noted that other devices and/or systems of devices provide both input and output capabilities such as remote computer(s) 744.

Computer 712 can operate in a networked environment using logical connections to one or more remote computers, such as remote computer(s) 744. The remote computer(s) 744 can be a personal computer, a server, a router, a network PC, a workstation, a microprocessor based appliance, a peer device or other common network node and the like, and typically includes many or all of the elements described relative to computer 712. For purposes of brevity, only a memory storage device 746 is illustrated with remote computer(s) 744. Remote computer(s) 744 is logically connected to computer 712 through a network interface 748 and then physically connected via communication connection 750. Network interface 748 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 750 refers to the hardware/software employed to connect the network interface 748 to the bus 718. While communication connection 750 is shown for illustrative clarity inside computer 712, it can also be external to computer 712. The hardware/software necessary for connection to the network interface 748 includes, for exemplary purposes only, internal and external technologies such as, modems including regular telephone grade modems, cable modems and DSL modems, ISDN adapters, and Ethernet cards.

FIG. 8 is a schematic block diagram of a sample-computing environment 800 that can be employed. The system 800 includes one or more client(s) 810. The client(s) 810 can be hardware and/or software (e.g., threads, processes, computing devices). The system 800 also includes one or more server(s) 830. The server(s) 830 can also be hardware and/or software (e.g., threads, processes, computing devices). The servers 830 can house threads to perform transformations by employing the components described herein, for example. One possible communication between a client 810 and a server 830 may be in the form of a data packet adapted to be transmitted between two or more computer processes. The system 800 includes a communication framework 850 that can be employed to facilitate communications between the client(s) 810 and the server(s) 830. The client(s) 810 are operably connected to one or more client data store(s) 860 that can be employed to store information local to the client(s) 810. Similarly, the server(s) 830 are operably connected to one or more server data store(s) 840 that can be employed to store information local to the servers 830.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A metadata processing and storage system, comprising:
an aggregator component that stores metadata from at least two disparate data domains; and
a framework component that encapsulates the metadata according to a common abstract meta-model capable of representing the metadata from the disparate data domains.

2. The system of claim 1, further comprising an application programming interface to interact with the aggregator component.

3. The system of claim 1, the framework component is associated with an entity data model.

4. The system of claim 4, the disparate data domains are associated with an Object Models, Relational Models, Service Contracts, Process Contracts, Conceptual Models, Reporting Models, or Analytical Models.

5. The system of claim 1, the disparate data domains are associated with one or more item collections.

6. The system of claim 5, the item collections are self-populated from several persistent data sources.

7. The system of claim 1, the aggregator component further comprising a query component to access data from the aggregator component.

8. The system of claim 6, the item collections encapsulate loading logic, serialization logic, or validation logic.

9. The system of claim 1, the aggregator component is associated with a metadata workspace that provides a registration service to register item collections.

10. The system of claim 1, further comprising at least one of a conceptual model, a database model, a client mapping component, an object mapping component, or a primitive type mapping component.

11. The system of claim 1, further comprising a query service or a type resolution service to operate with metadata.

12. The system of claim 1, further comprising a component that exposes data structures that are based at least in part as model instances and relationships between model instances.

13. The system of claim 11, type resolution service supports primitive types that serve as markers to translate a model across type systems.

14. The system of claim 1, further comprising a workspace component that provides cross-domain services.

15. The system of claim 1, further comprising a component to provide consumer specific extensibility or provider specific extensibility.

16. The system of claim 1, further comprising a metadata perspectives component to provide transparent translations from one primitive type system to another.

17. The system of claim 1, further comprising a component to project a conceptual model onto a target type system.

18. A method to store and process metadata, comprising:
defining an abstract language for a plurality of metadata forms;
retrieving a plurality of item collections associated with the metadata forms; and
aggregating the item collections in accordance with the abstract language.

19. The method of claim 18, further comprising providing an application programming interface to query the aggregated item collections.

20. A metadata aggregation system, comprising:
means for aggregating metadata from one or more metadata domains; and
means for representing the metadata according to a common metadata model, where the represented metadata applies as a generic form across the metadata domains.
